(19) United States
(12) Patent Application Publication
(10) Pub. No.: US 2003/0019955 A1
(43) Pub. Date: Jan. 30, 2003

(54) Fuel injection valve

(76) Inventors: Kurt Schraudner, Bamberg (DE); Josef Seidel, Breitenguessbach (DE)

Correspondence Address: KENYON & KENYON, ONE BROADWAY, NEW YORK, NY, 10004, US

(21) Appl. No.: 10/110,251

(22) PCT Filed: Jul. 13, 2001
(86) PCT No.: PCT/DE01/02622

(30) Foreign Application Priority Data
Aug. 10, 2001 (DE) 10038996.1

(51) Int. Cl. F02M 47/02

(52) U.S. Cl. 239/533.2; 239/88

(57) ABSTRACT

In a fuel injector for internal combustion engines having a valve housing, having an axially movable valve element for opening and closing an injection opening, and having a drive rod that operates in the closing direction of the valve element, the drive rod being guided in a bore hole of a valve piece that is inserted into the valve housing, and enclosing in the valve piece a control pressure chamber, which can be connected, via an intake channel that radially branches off from the control pressure chamber and that is provided with at least one intake throttle, to a high-pressure fuel connection, and that can be connected, via an outlet channel having an outlet throttle and being able to be closed by a control valve element, to a low-pressure fuel connection, in order to be able to set the fuel flow through the intake throttle, it is proposed that, in a through hole of the valve housing running radially with respect to the axis of the bore hole, a control element is arranged that can be fixed in position and moved from outside the valve housing, the control element, by way of a throttle needle facing the control pressure chamber, being able to be inserted into an intake opening of the intake channel for setting the flow cross section of the intake channel.

### BACKGROUND INFORMATION

The present invention relates to a fuel injector having the features of the preamble of claim 1.

A fuel injector of this type, which is also termed an injector, is known, by way of example, from German Patent 196 50 865 A1, and it is used in fuel injection systems that are equipped with a high-pressure fuel reservoir. In the known fuel injector, a valve needle is acted upon in the closing direction by the fuel pressure prevailing in the control pressure chamber via a drive rod. The control pressure chamber is arranged in a valve piece that is inserted into the valve housing and is connected, via an intake channel that is provided with an intake throttle, to a high-pressure fuel connection, and is connected, via an outlet channel provided with an outlet throttle, to a low-pressure fuel connection. Using a control valve element of a control valve, having, for example, a magnetic actuator or a piezo actuator, the outlet channel can be opened and closed, and, in this way, the fuel pressure in the control pressure chamber can be controlled for the individual actuating processes of the valve needle. The opening speed of the valve needle, when the outlet channel is opened, is determined by the flow differential between the intake throttle and the outlet throttle and therefore ultimately by the relative sizes of the intake and outlet throttles. Therefore, the intake throttle and the outlet throttle must be configured in the valve piece with great, precision. If the geometric dimensions of the intake throttle do not lie within the required tolerances, then the fuel injector must be disassembled and, for example, a new valve piece must be manufactured that has an adapted intake throttle, or the fuel outlet from the control pressure chamber must be adjusted by a change in the stroke of the control valve element.

### ADVANTAGES OF THE INVENTION

As a result of the fuel injector according to the present invention having the characterizing features of claim 1, these disadvantages are avoided.

This is achieved by a control element that is arranged in a through hole of the valve housing and that can be moved and fixed in position from outside the valve housing, and that can be inserted, by way of a throttle needle facing the control pressure chamber, into an intake opening of the intake channel. Using the control element, which can be set from outside the valve housing, the flow differential between the intake and outlet throttles and therefore the opening speed of the valve needle can be set in a simple manner. Thus, for example, in a readjustment of the injector in response to detected deviations from the predetermined fuel flow between the intake and outlet throttles, it is possible to set the flow cross section in the intake channel and therefore the flow properties of the fuel moving into the control pressure chamber, using the control element that can be actuated from outside, through a step-by-step insertion or removal of the throttle needle from the intake opening of the intake channel. For this purpose, the fuel injector does not have to be completely disassembled. The fuel injector according to the present invention therefore makes possible a simple readjustment in response to quantity deviations in the testing field.

Refinements and advantageous embodiments of the present invention are made possible by the features contained in the subclaims.

It is particularly advantageous if the control element can be screwed into the through hole of the valve housing. By a simple screwing-in of the control element into the through hole, the throttle needle can be inserted very simply and precisely into the intake opening of the intake channel. Just as easily, the throttle needle can be removed from the intake opening a small distance by rotating the control element in the reverse direction.

The through hole that accommodates the control element can advantageously be sealed by a sealing ring that is arranged between the valve housing and the control element, the sealing ring being pressed by the threaded control element against a sealing surface of the valve housing.

In one advantageous exemplary embodiment, it is provided that the intake opening of the intake channel be configured in a frustum shape.

It is particularly advantageous to adjust the flow cross section in the intake channel using a throttle needle that is configured in a conical shape. As a result of the cross-sectional surface of the throttle needle, which expands from the point of the cone, the flow cross section of the fuel flow in the intake channel is continuously reduced when the throttle needle is inserted into the intake opening. The flow cross section in the intake channel can be set particularly effectively if the vertical angle of the cone-shaped throttle needle is smaller than or equal to the opening angle of the frustum-shaped intake opening of the intake channel.

### DRAWINGS

Exemplary embodiments of the present invention are depicted in the drawings and are discussed in the description below. The following are the contents:

FIG. 1 depicts a cutaway view of the upper part of a fuel injector according to the present invention having a magnetic actuator,

FIG. 2 depicts a partial cutaway view of the valve piece from FIG. 1 in a plane which, in comparison to the plane depicted in FIG. 1, is rotated about the longitudinal axis of the fuel injector,

FIG. 3 depicts an enlarged detail from FIG. 2.

### DESCRIPTION OF EXEMPLARY EMBODIMENT

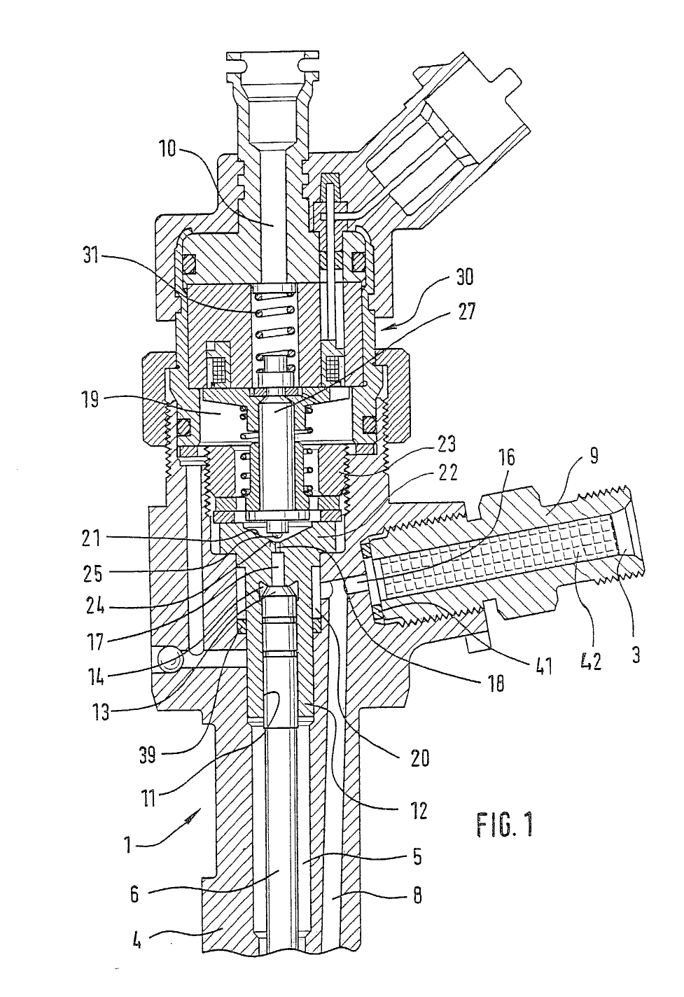

In FIG. 1, a cutaway view is depicted of an electrically controlled fuel injector, a so-called injector. The fuel injector is designed for use in a fuel injection system, which is equipped with a high-pressure fuel reservoir, which is continuously supplied with high-pressure fuel by a high-pressure pump, and the fuel can be supplied, under injection pressure, to the internal combustion engine from the reservoir via individual electrically controlled injection valves. Fuel injector 1 depicted in FIG. 1 has a valve housing 4 having a longitudinal bore hole 5, in which a piston-like drive rod 6 is arranged, which at one of its ends influences a valve element arranged in an undepicted nozzle body and configured as a valve needle. As a result of the closing force of a nozzle spring and the pressure force of drive rod 6, the valve needle closes at least one injection opening in the nozzle body. A pressure shoulder, which is arranged in a pressure chamber of the nozzle body, is configured on the valve needle in a familiar manner. The pressure chamber is supplied via a pressure bore hole 8 with fuel that is under high pressure. In response to an opening stroke movement of drive rod 6, the valve needle is lifted by the high-pressure fuel in the pressure chamber, which continuously acts upon the pressure shoulder in opposition to the closing force of the nozzle spring. The injection of the fuel into the combustion chamber of the internal combustion engine then takes place through the injection opening that is connected to the pressure chamber. As a result of the sinking of the drive rod, the valve needle is pressed in the closing direction of the spring force of the nozzle spring into the valve seat of the injection valve, and the injection cycle is terminated.

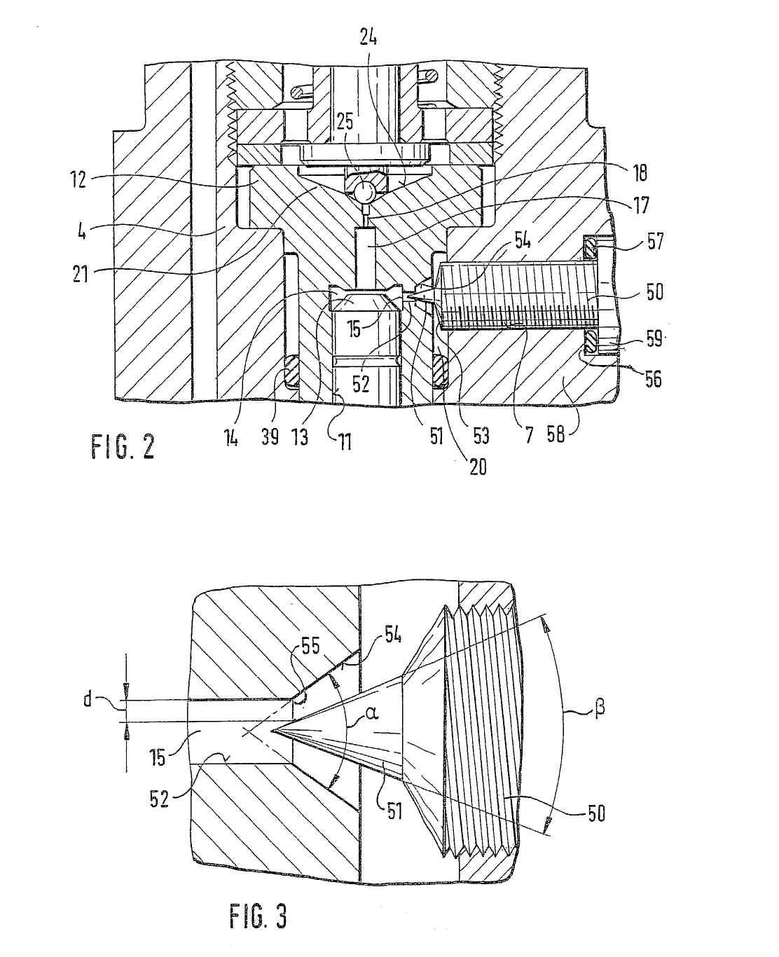

As can be seen in FIG. 1, drive rod 6, with its end opposite the valve needle, is guided in cylinder bore hole 11 of a valve piece 12 that is inserted into valve housing 4. In cylinder bore hole 11, end face 13 of drive rod 6 encloses a control pressure chamber 14. As can also be seen from the cutaway representation of FIG. 2, control pressure chamber 14 is connected via an intake channel 15 to an annular chamber 20, which, as can be seen in FIG. 1, is connected via a high-pressure fuel connection 16 to a connection piece 3, which has a fuel filter 42 and which functions as the connection to the high-pressure fuel reservoir. Annular chamber 20 is sealed from longitudinal bore hole 5 by a sealing ring 39. Via intake channel 15, control pressure chamber 14 is exposed to the high pressure of the fuel prevailing in the high-pressure fuel reservoir.

Co-axial with respect to drive rod 6, a bore hole running in valve piece 12 branches off from control pressure chamber 14, the bore hole forming an outlet channel 17 that is provided with an outlet throttle 18, the channel emptying into a pressure relief chamber 19, which is connected to a low-pressure fuel connection 10, which in turn, in an undepicted manner, is connected to a fuel return line of injection valve 1. The outflow of outlet channel 17 from valve piece 12 takes place in the area of a cone-shaped, countersunk part 21 of the external end face of valve piece 12. In this context, valve piece 12 in a flange area 22 is fixedly braced by screw member 23 against valve housing 4. In cone-shaped part 21, a valve seat 24 is configured, with which a control valve element 25 of a solenoid valve 30 cooperates, controlling the injection valve. The control valve element is arranged on a stay bolt 27, which is continuously acted upon in the closing direction by a closing spring 31 that is supported against the housing, so that control valve element 25 normally contacts valve seat in the closing position, and control pressure chamber 14 is closed towards discharge relief side 19, so that the high pressure there builds up very rapidly via intake channel 15, the pressure also being present in the high-pressure fuel reservoir. Via the surface of end face 13, the pressure in control pressure chamber 14 generates a closing force on drive rod 6 and on the valve needle connected thereto, which is greater than the forces operating, on the other hand, in the opening direction as a consequence of the available high pressure. If control pressure chamber 14 is opened as a result of the opening of the solenoid valve towards discharge relief side 19, then the pressure in the small volume of control pressure chamber 14 decreases very rapidly, because the chamber is decoupled from the high-pressure side by an intake throttle that is further depicted below. As a result, the force acting upon the valve needle in the opening direction from the high pressure of the fuel exerted on the valve needle predominates, so that the valve needle moves upward and, in this context, the at least one injection opening is opened for an injection. However, if solenoid valve 30 closes outlet channel 17, then the pressure in control pressure chamber 14, as a result of the fuel flowing through intake channel 15, can once again be built up, so that the original closing force is available, and it closes the valve needle of the fuel injector. Of course, in place of the magnetic actuator, cooperating with control valve element 25, it is also possible to use a piezo actuator or a combination of a piezo actuator and a magnetic actuator, or a different part.

The design of fuel injector 1 that is described above essentially corresponds to the fuel injectors known from the related art. In the fuel injectors known from the related art, the intake throttle is configured by a bore hole in the side wall of the valve piece. The fuel inflow from annular chamber 20 into control pressure chamber 14 cannot be changed from the outside, because, in accordance with the assembly of the fuel injector, the relationship between fuel inflow and fuel outflow is fixedly set.

In the fuel injector according to the present invention, in contrast to the related art, a control element 50 is provided, which is arranged so as to be movable in a through hole 7 of valve housing 4 running radially with respect to the axis of bore hole 11. In this exemplary embodiment, control element 50 can be screwed into through hole 7. However, it is also possible to configure control element 50, for example, as a sliding sleeve or in another manner. It is important that the control element be movable with respect to control pressure chamber 14 and that it be capable of being fixed in a position once adopted. This can be achieved in a simple manner by introducing a threaded bore hole into side wall 58 of valve housing 4 and by configuring the control element so as to be capable of being screwed. At end 53 of control element 50, inserted into through hole 7, there is a conical throttle needle 51 protruding toward control pressure chamber 14. The throttle needle, however, can also have a different appropriate shape. In a recess 56 of side wall 58 of the valve housing, facing the outer environment, a sealing ring 57 is arranged, which is pressed by a collar 59 of control element 50 into recess 56 and in this way seals through hole 7. Advantageously, the thread in through hole 7 is configured so as to have a small rate of rise, in order to make it possible to adjust control element 50 more effectively. When control element 50 is set, the control element continually presses sealing ring 57 against housing wall 58, so that through hole 7 is continually sealed.

As can best be seen in FIG. 3, the intake channel of the fuel injector according to the present invention surrounds a bore hole 52 that passes through the wall of valve piece 12 radially with respect to the axis of bore hole 11, at whose end facing annular chamber 20 a frustum-shaped intake opening 54 is connected, which opens toward annular chamber 20 surrounding valve piece 12 on the periphery. As can be seen in FIG. 3, frustum-shaped intake opening 54 along with cylindrical bore hole 52 forms a circumferential edge 55. Vertical angle β of conical throttle needle 51 is advantageously smaller than or equal in size to opening angle a of frustum-shaped intake opening 54 of intake channel 15.

When control element 51 is screwed in, it penetrates, along with throttle needle 51, into the middle of intake opening 54 of intake channel 15. In this context, the tip of throttle needle 51 can penetrate somewhat into bore hole 52. As can be seen in FIG. 3, by inserting the throttle needle, the flow cross section of intake channel 15 is reduced. In FIG. 3, the flow cross section results from distance d of edge 55 of intake channel 15 from the sleeve surface of conical throttle needle 51. The farther throttle needle 51 is inserted into intake opening 54, the smaller this distance d becomes. By screwing in or removing control element 50, it is possible in a simple manner to change the flow cross section for the fuel flowing into the control pressure chamber and, as a result, to set the speed with which the control pressure chamber fills with fuel and with which the valve needle closes.

What is claimed is:

1. A fuel injector (1) for internal combustion engines, having a valve housing (4) and an axially movable valve element for opening and closing an injection opening of the injection valve and having a drive rod (6) that operates in the closing direction of the valve element; the drive rod with its end (13) facing away from the injection opening being guided in a bore hole (11) of a valve piece (12) that is inserted into the valve housing (4); and with this end (13) in the valve piece, enclosing a control pressure chamber (14); the control pressure chamber (14) being able to be connected to a high-pressure fuel connection (16) via an intake channel (15) that branches off radially from the control pressure chamber (14) and that is provided with at least one intake throttle (51), and being able to be connected to a low-pressure fuel connection (10) via an outlet channel (17) that has an outlet throttle (18) and that is able to be closed by a movable control valve element (25), the injection process being controllable by the control-pressure-chamber fuel pressure, that is controlled by the control valve element (25), wherein, in a through hole (7) of the valve housing (4) running radially with respect to the axis of the bore hole (11), a control element (50) is arranged that can be fixed in position and moved from outside the valve housing (4), the control element, by way of a throttle needle (51) that faces the control pressure chamber (14), being able to be inserted into an intake opening (54) of the intake channel (15) for adjusting the flow cross section of the intake channel (15).

2. The fuel injector as recited in claim 1, wherein the control element (50) is able to be screwed into the through hole (7) of the valve housing (4).

3. The fuel injector as recited in claim 2, wherein, by screwing the control element (50) into the through hole (7), the throttle needle (51) is able to be inserted into the intake opening (54) of the intake channel (15).

4. The fuel injector as recited in claim 3, wherein the through hole (7) is sealed by a sealing ring (57) that is arranged between the valve housing (4) and the control element (50), the sealing ring being pressed by the tensional force of the control element (50) against a sealing surface (56) of the valve housing.

5. The fuel injector as recited in claim 1, wherein the intake opening (54) of the intake channel (15) is configured so as to be frustum-shaped.

6. The fuel injector as recited in claim 1, wherein the throttle needle (51) is configured so as to be conical.

7. The fuel injector as recited in claim 5 and 6, wherein the vertical angle (β) of the conical throttle needle (51) is smaller than or the same size as the opening angle (α) of the frustum-shaped intake opening (54) of the intake channel (15).
